(19) United States
(12) Patent Application Publication
(10) Pub. No.: US 2015/0244007 A1
(43) Pub. Date: Aug. 27, 2015

(54) POWER GENERATION SYSTEM AND METHOD OF OPERATING POWER GENERATION SYSTEM

(71) Applicant: MITSUBISHI HITACHI POWER SYSTEMS, LTD., Kanagawa (JP)

(72) Inventors: Yukimasa Nakamoto, Tokyo (JP); Kazunori Fujita, Tokyo (JP); So Manabe, Tokyo (JP)

(21) Appl. No.: 14/436,281

(22) PCT Filed: Nov. 12, 2013
(86) PCT No.: PCT/JP2013/080572

§ 371 Date: Apr. 16, 2015

(30) Foreign Application Priority Data
Nov. 22, 2012 (JP) 2012-256907

(51) Int. Cl. H01M 8/04

(52) U.S. Cl. CPC H01M 8/04111; H01M 2008/1293

(57) ABSTRACT

A power generation system includes a fuel cell, a gas turbine, a first compressed air supply line that supplies the air from a compressor to a combustor, a second compressed air supply line that supplies compressed air from the compressor to the fuel cell, a compressed air circulating line that supplies exhausted air from the fuel cell to the combustor, a detection unit that detects ease of flow of compressed air in the fuel cell, an adjustment unit that adjusts balance between ease of flow of the compressed air in the first compressed air supply line and ease of flow of the compressed air in the second compressed air supply line.

### FIELD

The present invention relates to a power generation system in which a solid oxide fuel cell, a gas turbine, and a steam turbine are combined, and a method of operating a power generation system.

### BACKGROUND

A solid oxide fuel cell (hereinafter, SOFC) is well known as a highly efficient fuel cell having various uses. The operation temperature of the SOFC is set to a high temperature in order to enhance ionic conductivity. Therefore, compressed air emitted from a compressor of a gas turbine can be used as air (oxidant) to be supplied to a cathode side. Further, a high-temperature exhausted fuel gas discharged from the SOFC can be used as a fuel of a combustor of the gas turbine.

Therefore, for example, as described in Patent Literature 1 below, as a power generation system that can achieve high-efficient power generation, various proposals of combinations of the SOFC, the gas turbine, and the steam turbine have been given. In the combined systems described in Patent Literature 1, the gas turbine includes a compressor that compresses air and supplies the air to the SOFC, and a combustor that generates a combustion gas from the exhausted fuel gas discharged from the SOFC and the compressed air.

### CITATION LIST

### Patent Literature

Patent Literature 1: Japanese Patent Application Laid-open No. 2009-205930

### SUMMARY

### Technical Problem

The above-described conventional power generation system includes a path that supplies the compressed air from the compressor of the gas turbine to the combustor, and a path that supplies the compressed air from the compressor to the fuel cell such as SOFC. The power generation system increases the amount of air to be supplied to the fuel cell by gradually opening a valve of the path that supplies the compressed air from the compressor to the fuel cell while gradually closing a valve of the path that supplies the compressed air from the compressor to the combustor at the time of start to supply the compressed air to the fuel cell.

Here, in the power generation system, when a drive state between the fuel cell and the gas turbine varies, the pressure of the compressed air supplied from the compressor to the fuel cell may vary. When the pressure of the compressed air to be supplied to the fuel cell varies in the power generation system, the pressure at an cathode side of the fuel cell varies, so that pressure balance between an cathode and a anode cannot be maintained constant. Therefore, when the pressure balance between the cathode and the anode cannot be maintained, performance of the fuel cell is deteriorated.

The present invention solves the above problem, and an objective is to provide a power generation system and a method of operating a power generation system that can stabilize the pressure of compressed air to be supplied to a fuel cell.

### Solution to Problem

According to an aspect of the invention, a power generation system comprises: a fuel cell; a gas turbine including a compressor and a combustor; a first compressed air supply line configured to supply compressed air from the compressor to the combustor; a second compressed air supply line configured to supply the compressed air from the compressor to the fuel cell; a compressed air circulating line configured to supply exhausted air from the fuel cell to the combustor; a detection unit configured to detect ease of flow of compressed air in the fuel cell; an adjustment unit configured to adjust balance between ease of flow of the compressed air in the first compressed air supply line and ease of flow of the compressed air in the second compressed air supply line; and a control device configured to adjust the balance between ease of flow of the compressed air in the first compressed air supply line and ease of flow of the compressed air in the second compressed air supply line by the adjustment unit, based on variation of the ease of flow of the compressed air in the fuel cell detected in the detection unit.

Therefore, the balance between the ease of flow of the compressed air in the first compressed air supply line and the ease of flow of the compressed air in the second compressed air supply line can be adjusted based on the ease of flow of the compressed air in the fuel cell. Accordingly, variation of the compressed air to be supplied to the fuel cell due to influence of variation of the fuel cell can be suppressed, and the pressure of the compressed air to be supplied to the fuel cell can be stabilized.

Advantageously, in the power generation system, the adjustment unit includes a mechanism arranged at the first compressed air supply line, and which adjusts the ease of flow of the compressed air in the first compressed air supply line.

Therefore, the ease of flow of the compressed air in the first compressed air supply line is adjusted, whereby the balance between the compressed air to be supplied to the fuel cell and the compressed air to be supplied to the combustor can be favorably adjusted.

Advantageously, in the power generation system, the adjustment unit includes a control valve with an adjustable degree of opening, arranged at the first compressed air supply line.

Therefore, the ease of flow of the compressed air in the first compressed air supply line is adjusted by adjustment of the degree of opening of the control valve, whereby the balance between the compressed air to be supplied to the fuel cell and the compressed air to be supplied to the combustor can be favorably adjusted.

Advantageously, in the power generation system, the adjustment unit includes main piping arranged at the first compressed air supply line, at least one diverging pipe that bypasses the main piping, and an open/close valve arranged at the diverging pipe.

Therefore, the ease of flow of the compressed air in the first compressed air supply line is adjusted by adjustment of the number of opened open/close valves (the number of closed open/close valves), whereby the balance between the compressed air to be supplied to the fuel cell and the compressed air to be supplied to the combustor can be favorably adjusted.

Advantageously, in the power generation system, when the compressed air becomes less easy to flow to the fuel cell, the control device causes the compressed air to become easy to flow in the first compressed air supply line.

Therefore, a decrease in the compressed air to be supplied through the second compressed air supply line to the fuel cell can be suppressed in accordance with variation of the ease of flow of the compressed air, and the pressure of the compressed air to be supplied to the fuel cell can be stabilized.

Advantageously, in the power generation system, the adjustment unit includes a mechanism arranged at the second compressed air supply line, and which adjusts the ease of flow of the compressed air in the second compressed air supply line.

Therefore, the ease of flow of the compressed air in the second compressed air supply line is adjusted, whereby the balance between the compressed air to be supplied to the fuel cell and the compressed air to be supplied to the combustor can be favorably adjusted.

Advantageously, in the power generation system, the adjustment unit includes a control valve with an adjustable degree of opening arranged at the second compressed air supply line.

Therefore, the ease of flow of the compressed air in the second compressed air supply line is adjusted by adjustment of the degree of opening of the control valve, whereby the balance between the compressed air to be supplied to the fuel cell and the compressed air to be supplied to the combustor can be favorably adjusted.

Advantageously, in the power generation system, when the compressed air becomes less easy to flow to the fuel cell, the control device causes the compressed air to become less easy to flow in the second compressed air supply line.

Therefore, a decrease in the compressed air to be supplied to the fuel cell can be suppressed in accordance with variation of the ease of flow of the compressed air. Accordingly, the decrease in the compressed air to be supplied through the second compressed air supply line to the fuel cell can be suppressed, and the pressure of the compressed air to be supplied to the fuel cell can be stabilized.

Advantageously, in the power generation system, when the control device determines to block a circulating path of the compressed air of the fuel cell and the gas turbine, the control device repeats control to cause the compressed air to become less easy to flow in the second compressed air supply line and to cause the compressed air to become easier to flow in the first compressed air supply line by the adjustment unit, to close the second compressed air supply line.

Therefore, variation of the amount of the compressed air to be supplied to a combustion chamber can be suppressed when a circulating path of the compressed air of the gas turbine and the fuel cell is blocked.

Advantageously, in the power generation system, the detection unit includes a first pressure detection unit that detects a pressure of the compressed air flowing in the first compressed air supply line, and a second pressure detection unit that detects a pressure of the compressed air flowing in the compressed air circulating line, and detects the ease of flow of the compressed air in the fuel cell, based on a result detected in the first pressure detection unit and a result detected in the second pressure detection unit.

Therefore, the ease of flow of the compressed air can be detected by a simple detection mechanism.

According to another aspect of the present invention, a method of operating a power generation system including a fuel cell, a gas turbine including a compressor and a combustor, a first compressed air supply line that supplies compressed air from the compressor to the combustor, a second compressed air supply line that supplies the compressed air from the compressor to the fuel cell, and a compressed air circulating line that supplies exhausted air from the fuel cell to the combustor, comprises: detecting ease of flow of compressed air in the fuel cell; and adjusting balance between ease of flow of the compressed air in the first compressed air supply line and ease of flow of the compressed air in the second compressed air supply line by the adjustment unit, based on variation of the ease of flow of the compressed air in the fuel cell detected in the detection unit.

The balance between the ease of flow of the compressed air in the first compressed air supply line and the ease of flow of the compressed air in the second compressed air supply line is adjusted based on the ease of flow of the compressed air in the fuel cell, whereby variation of the compressed air to be supplied to the fuel cell due to influence of variation of the fuel cell can be suppressed. Accordingly, the pressure of the compressed air to be supplied to the fuel cell can be stabilized.

### Advantageous Effects of Invention

According to the power generation system and the method of operating a power generation system of the present invention, the balance between the ease of flow of the compressed air in the first compressed air supply line and the ease of flow of the compressed air in the second compressed air supply line is adjusted based on the ease of flow of the compressed air in the fuel cell, whereby variation of the pressure of the compressed air to the supplied to the fuel cell can be suppressed. Accordingly, the pressure of the compressed air to be supplied to the fuel cell can be stabilized.

### BRIEF DESCRIPTION OF DRAWINGS

FIG. 1 is a schematic configuration diagram illustrating a power generation system of the present embodiment.

FIG. 2 is a schematic diagram illustrating a gas turbine, an SOFC, and piping system in a power generation system according to an embodiment of the present invention.

FIG. 3 is a flowchart illustrating an example of a drive operation of the power generation system of the present embodiment.

FIG. 4 is a flowchart illustrating an example of the drive operation of the power generation system of the present embodiment.

FIG. 5 is a schematic diagram illustrating another example of a gas turbine, an SOFC, and a piping system.

FIG. 6 is a flowchart illustrating an example of a drive operation of a power generation system.

FIG. 7 is a schematic diagram illustrating another example of a gas turbine, an SOFC, and a piping system.

FIG. 8 is a flowchart illustrating an example of a drive operation of a power generation system.

FIG. 9 is a schematic configuration diagram illustrating another example of a first compressed air supply line.

### DESCRIPTION OF EMBODIMENTS

Hereinafter, favorable embodiments of a power generation system and a method of generating a power generation system according to the present invention will be described in detail with reference to the appended drawings. Note that the present invention is not limited by these embodiments, and includes ones configured from combined embodiments when there is a plurality of embodiments.

### Embodiments

A power generation system of the present embodiment is a Triple Combined Cycle (registered trademark) that is a combination of a solid oxide fuel cell (hereinafter, referred to as SOFC), a gas turbine, and a steam turbine. The Triple Combined Cycle can generate power in three stages of the SOFC, the gas turbine, and the steam turbine by installing the SOFC at an upper stream side of gas turbine combined cycle power generation (GTCC), and thus can realize extremely high power generation efficiency. Note that, in the description below, a solid oxide fuel cell is applied as the fuel cell of the present invention and description will be given. However, the fuel cell of the present invention is not limited to the fuel cell of this form.

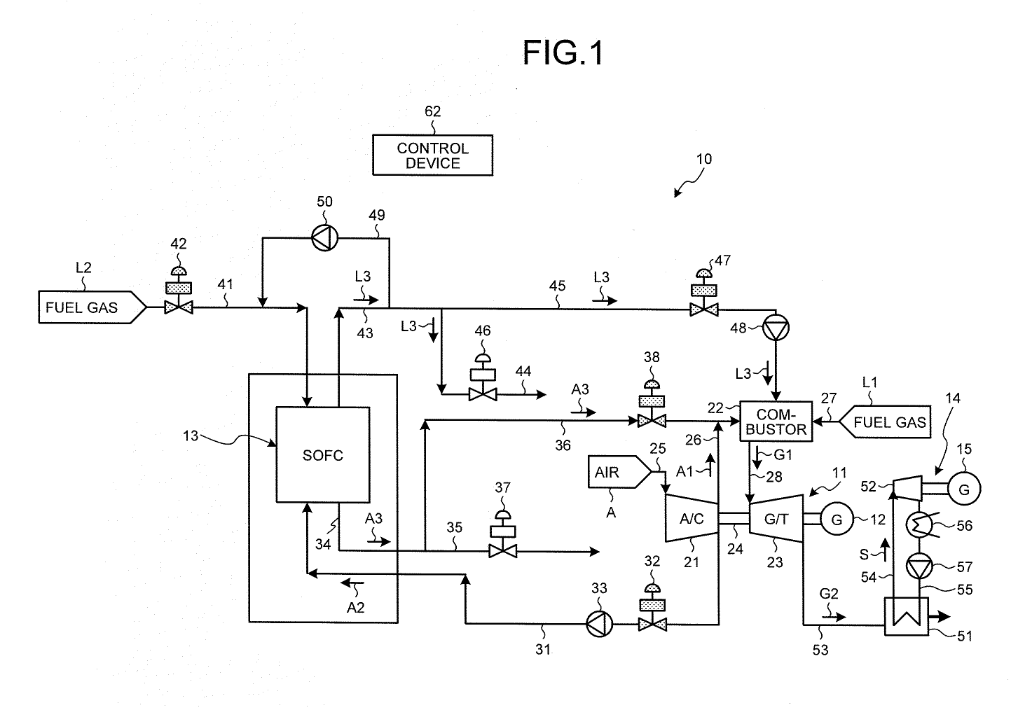

FIG. 1 is a schematic configuration diagram illustrating a power generation system of the present embodiment. In the present embodiment, as illustrated in FIG. 1, a power generation system 10 includes a gas turbine 11, a generator 12, an SOFC 13, a steam turbine 14, and a generator 15. The power generation system 10 is configured to obtain high power generation efficiency, by combining power generation by the gas turbine 11, power generation by the SOFC 13, and power generation of the steam turbine 14. Further, the power generation system 10 includes a control device 62. The control device 62 controls operations of units of the power generation system 10, based on input setting, an input instruction, a result detected in a detection unit, and so on.

The gas turbine 11 includes a compressor 21, a combustor 22, and a turbine 23, and the compressor 21 and the turbine 23 are coupled with a rotation axis 24 in an integrally rotatable manner. The compressor 21 compresses air A taken in from an air taking-in line 25. The combustor 22 mixes and burns compressed air A1 supplied from the compressor 21 through a first compressed air supply line 26, and a fuel gas L1 supplied through a first fuel gas supply line 27. The turbine 23 is rotated by a combustion gas G1 supplied from the combustor 22 through a flue gas supply line 28. Note that, although not illustrated, the compressed air A1 compressed in the compressor 21 is supplied to the turbine 23 through a casing, and the turbine 23 cools a blade and so on using the compressed air A1 as cooling air. The generator 12 is provided on the same axis as the turbine 23, and can generate power by rotation of the turbine 23. Note that, here, a liquefied natural gas (LNG) is used as the fuel gas L1 supplied to the combustor 22.

The SOFC 13 reacts and generates power at a predetermined operation temperature by supply of a high-temperature fuel gas as a reductant, and high-temperature air (oxidized gas) as an oxidant. The SOFC 13 is configured such that a cathode, a solid electrolyte, and a anode are housed in a pressure container. The SOFC 13 generates the power by supply of a part of compressed air A2 compressed in the compressor 21 to the cathode, and a fuel gas L2 to the anode. Note that, here, as the fuel gas L2 supplied to the SOFC 13, a liquefied natural gas (LNG), hydrogen (H₂), a hydrocarbon gas such as carbon monoxide (CO) or methane (CH₄), a gas manufactured in a gasification facility of a carbonaceous material such as coal is used, for example. Further, the oxidized gas supplied to the SOFC 13 is a gas containing approximately 15% to 30% of oxygen, and typically, air is favorable. However, a mixed gas of a burned flue gas and air, a mixed gas of oxygen and air, or the like, other than air, can be used (hereinafter, the oxidized gas supplied to the SOFC 13 is referred to as air).

A second compressed air supply line 31 diverging from the first compressed air supply line 26 is coupled with the SOFC 13, and a part of the compressed air A2 compressed in the compressor 21 can be supplied to an introduction part of the cathode. The second compressed air supply line 31 includes a control valve 32 that can adjust the amount of air to be supplied and a blower (booster) 33 that can increase the pressure of the compressed air A2 along a flow direction of the compressed air A2. The control valve 32 is provided at an upper stream side of the flow direction of the compressed air A2, and the blower 33 is provided at a downstream side of the control valve 32, in the second compressed air supply line 31. An exhausted air line 34 that discharges compressed air A3 (exhausted air) used in the cathode is coupled with the SOFC 13. The exhausted air line 34 diverges into a discharge line 35 that discharges the compressed air A3 used in the cathode to an outside, and a compressed air circulating line 36 coupled with the combustor 22. The discharge line 35 includes a control valve 37 that can adjust the amount of air to be discharged, and the compressed air circulating line 36 includes a control valve 38 that can adjust the amount of circulating air.

Further, the SOFC 13 includes a second fuel gas supply line 41 that supplies the fuel gas L2 to an introduction part of the anode. The second fuel gas supply line 41 includes a control valve 42 that can adjust the amount of the fuel gas to be supplied. A exhausted fuel line 43 that discharges a exhausted fuel gas L3 used in the anode is coupled with the SOFC 13. The exhausted fuel line 43 diverges into a discharge line 44 that discharges the exhausted fuel gas L3 to an outside, and a exhausted fuel gas supply line 45 coupled with the combustor 22. The discharge line 44 includes a control valve 46 that can adjust the amount of the fuel gas to be discharged, and the exhausted fuel gas supply line 45 includes a control valve 47 that can adjust the amount of the fuel gas to be supplied, and a blower 48 that can increase the pressure of the exhausted fuel gas L3 along a flow direction of the exhausted fuel gas L3. The control valve 47 is provided at an upper stream side of the flow direction of the exhausted fuel gas L3, and the blower 48 is provided at a downstream side of the control valve 47, in the exhausted fuel gas supply line 45.

Further, a fuel gas recirculating line 49 that couples the exhausted fuel line 43 and the second fuel gas supply line 41 is provided in the SOFC 13. The fuel gas recirculating line 49 includes a recirculating blower 50 that allows the exhausted fuel gas L3 in the exhausted fuel line 43 to recirculate in the second fuel gas supply line 41.

In the steam turbine 14, a turbine 52 is rotated by steam generated in an exhausted heat recovery boiler (HRSG) 51. A steam supply line 54 and a feed water line 55 are provided between the steam turbine 14 (turbine 52) and the exhausted heat recovery boiler 51. The feed water line 55 includes a condenser 56 and a feed water pump 57. A flue gas line 53 from the gas turbine 11 (turbine 23) is coupled with the exhausted heat recovery boiler 51, and the exhausted heat recovery boiler 51 performs heat exchange between a high-temperature flue gas G2 supplied through the flue gas line 53 and water supplied through the feed water line 55 to generate steam S. The generator 15 is provided on the same axis as the turbine 52, and can generate power by rotation of the turbine 52. Note that the flue gas G2 from which heat is recovered in the exhausted heat recovery boiler 51 is released into the air after toxic substances are removed.

Here, an operation of the power generation system 10 of the present embodiment will be described. When the power generation system 10 is started, the gas turbine 11, the steam turbine 14, and the SOFC 13 are started in the order of the description.

First, in the gas turbine 11, the compressor 21 compresses the air A, the combustor 22 mixes and burns the compressed air A1 and the fuel gas L1, and the generator 12 starts to generate the power by rotation of the turbine 23 by the combustion gas G1. Next, in the steam turbine 14, the turbine 52 is rotated by the steam S generated by the exhausted heat recovery boiler 51, and the generator 15 starts to generate the power, accordingly.

Following that, to start the SOFC 13, the compressed air A2 is supplied from the compressor 21 and pressurization of the SOFC 13 is started, and heating is started. The control valve 32 is opened by a predetermined degree of opening in a state where the control valve 37 of the discharge line 35 and the control valve 38 of the compressed air circulating line 36 are closed, and the blower 33 of the second compressed air supply line 31 is stopped. Then, a part of the compressed air A2 compressed in the compressor 21 is supplied through the second compressed air supply line 31 to the SOFC 13 side. Accordingly, the pressure at the cathode side of the SOFC 13 is increased by the compressed air A2 being supplied.

Meanwhile, the fuel gas L2 is supplied and pressurization is started at the anode side of the SOFC 13. The control valve 42 of the second fuel gas supply line 41 is opened and the recirculating blower 50 of the fuel gas recirculating line 49 is driven in a state where the control valve 46 of the discharge line 44 and the control valve 47 of the exhausted fuel gas supply line 45 are closed, and the blower 48 is stopped. Then, the fuel gas L2 is supplied through the second fuel gas supply line 41 to the SOFC 13, and the exhausted fuel gas L3 recirculates in the fuel gas recirculating line 49. Accordingly, the pressure at the anode side of the SOFC 13 is increased by the fuel gas L2 being supplied.

Then, when the pressure at the cathode side of the SOFC 13 becomes an output pressure of the compressor 21, the control valve 32 is fully opened, and the blower 33 is driven. At the same time, the control valve 37 is opened, and the compressed air A3 from the SOFC 13 is discharged through the discharge line 35. Then, the compressed air A2 is supplied to the SOFC 13 side by the blower 33. At the same time, the control valve 46 is opened, and the exhausted fuel gas L3 from the SOFC 13 is discharged through the discharge line 44. Then, when the pressure at the cathode side and the pressure at the anode side in the SOFC 13 reach a target pressure, the pressurization of the SOFC 13 is completed.

Following that, when a reaction (power generation) of the SOFC 13 is stabilized, and the compressed air A3 and the components of the exhausted fuel gas L3 are stabilized, the control valve 38 is opened while the control valve 37 is closed. Then, the compressed air A3 from the SOFC 13 is supplied through the compressed air circulating line 36 to the combustor 22. Further, the control valve 47 is opened and the blower 48 is driven while the control valve 46 is closed. Then, the exhausted fuel gas L3 from the SOFC 13 is supplied through the exhausted fuel gas supply line 45 to the combustor 22. At this time, the amount of the fuel gas L1 supplied through the first fuel gas supply line 27 to the combustor 22 is decreased.

Here, all of the power generation in the generator 12 by driving of the gas turbine 11, the power generation in the SOFC 13, and the power generation in the generator 15 by driving of the steam turbine 14 are performed, whereby the power generation system 10 is steadily operated.

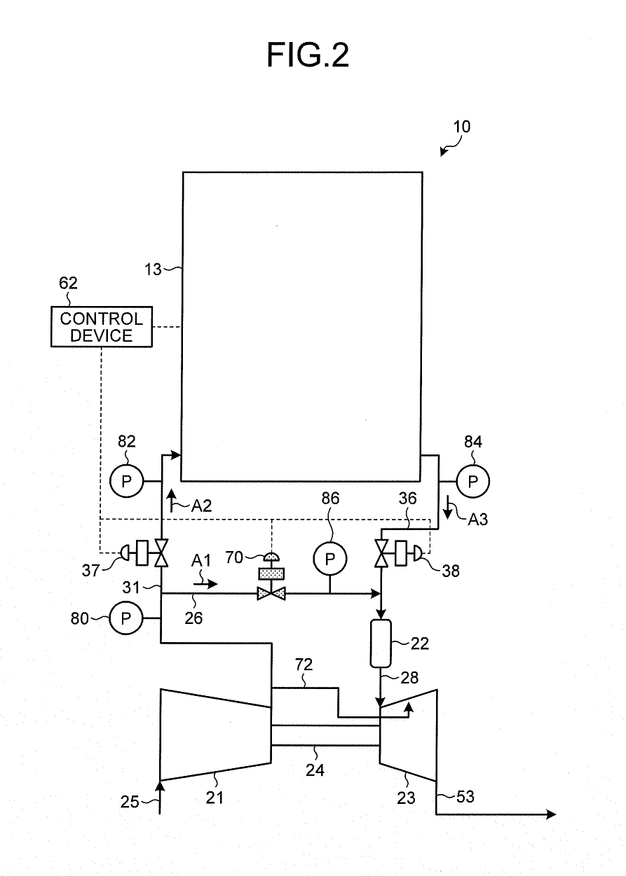

FIG. 2 is a schematic diagram illustrating the gas turbine, the SOFC, and the piping system in the power generation system according to an embodiment of the present invention. By the way, in a typical power generation system, the compressed air discharged from the compressor 21 is supplied to both of the SOFC 13 and the combustor 22. Also, the compressed air discharged from the compressor 21 is supplied to the turbine 23 using a cooling air supply line 72, and is also used as air to cool the turbine 23.

Here, in the power generation system, ease of flow of the air in the SOFC 13 varies due to various reasons such as variation of a drive state between the fuel cell and the gas turbine. When the ease of flow of the air in the SOFC 13 varies, relationship between a ratio of the compressed air A2 to be supplied to the SOFC 13 and a ratio of the compressed air A1 to be supplied to the combustor 22, of the compressed air discharged from the compressor 21, varies, and the pressure of the compressed air A2 to be supplied to the SOFC 13 varies.

Therefore, in the power generation system 10 of the present embodiment, as illustrated in FIG. 2, the control valve 37 that adjusts ease of flow of the compressed air A2 in the second compressed air supply line 31, a bypass control valve (control valve) 70 that adjusts ease of flow of the compressed air A1 in the first compressed air supply line 26, and pressure detection units 80, 82, 84, and 86 are provided. The pressure detection units 80, 82, 84, and 86 serve as detection units that detect the ease of flow of the compressed air in the SOFC 13 of the present embodiment. A control device (control unit) 62 of the power generation system 10 drives the control valve 37 and the bypass control valve 70, based on detection results of the pressure detection units 80, 82, 84, and 86.

The power generation system 10 detects the ease of flow of the compressed air in the SOFC 13, based on a difference between the pressure of the compressed air A2 detected by the pressure detection unit 82 and the pressure of the compressed air A3 detected by the pressure detection unit 84, and controls the degrees of opening of the control valve 37 and the bypass control valve 70, based on the detection result. With the control, the power generation system 10 can adjust balance between the ease of flow of the compressed air A1 in the first compressed air supply line 26 and the ease of flow of the compressed air A2 in the second compressed air supply line 31. Accordingly, the power generation system 10 can stabilize the pressure of the compressed air A2 to be supplied to the SOFC 13.

To be specific, as illustrated in FIG. 2, the bypass control valve 70 is installed at the first compressed air supply line 26. The bypass control valve 70 switches circulation of the compressed air A1 to the first compressed air supply line 26 by switching open/close, and controls the ease of flow and the flow rate of the compressed air A1 flowing in the first compressed air supply line 26, and a pressure difference between an upper stream and a downstream of the bypass control valve 70 by adjusting the degree of opening. Further, as described above, the control valve 37 is installed at the second compressed air supply line 31, and can perform adjustment with respect to the second compressed air supply line 31, which is similar to the bypass control valve 70, by adjusting open/close and the degree of opening.

The pressure detection unit 80 is provided at a line through which the compressed air is discharged from the compressor 21. To be specific, the pressure detection unit 80 is provided at a line before diverging into the first compressed air supply line 26 and the second compressed air supply line 31. The pressure detection unit 80 detects the pressure of the compressed air to be discharged from the compressor 21. The pressure detection unit 82 is arranged at a downstream side of the control valve 37 of the second compressed air supply line 31 and at an upper stream side of the SOFC 13. The pressure detection unit 82 detects the pressure of the compressed air A2 to be supplied to the SOFC 13. The pressure detection unit 84 is arranged at a downstream side of the SOFC 13 of the compressed air circulating line 36 and at an upper stream side of the control valve 38. The pressure detection unit 84 detects the pressure of the compressed air A3 discharged from the SOFC 13. The pressure detection unit 86 is arranged at a downstream side of the by-bass control valve 70 of the first compressed air supply line 26 and at an upper stream side of a coupled portion of the compressed air circulating line 36. The pressure detection unit 86 detects the pressure of the compressed air A1 that has passed the bypass control valve 70.

The control device 62 can adjust the degree of opening of at least one of the control valve 37 and the bypass control valve 70. Therefore, the control device 62 can adjust the ease of flow of the compressed air in at least one of the first compressed air supply line 26 and the second compressed air supply line 31. Accordingly, the control device 62 can adjust the balance between the ease of flow of the compressed air A1 in the first compressed air supply line 26 and the ease of flow of the compressed air A2 in the second compressed air supply line 31.

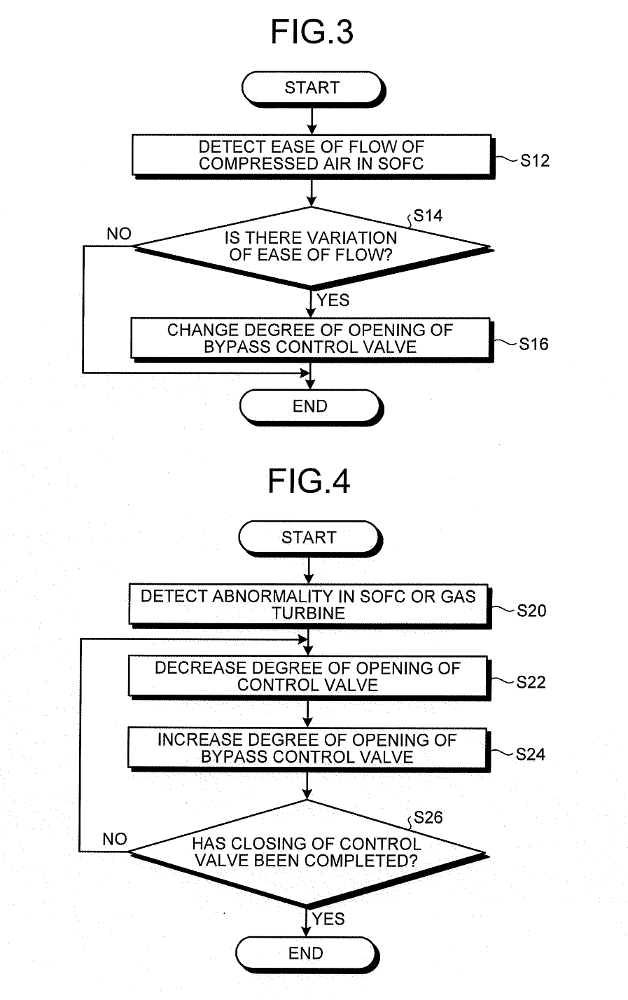

Hereinafter, a method of driving the power generation system 10 of the present embodiment will be described with reference to FIG. 3. FIG. 3 is a flowchart illustrating an example of a drive operation of the power generation system of the present embodiment. The drive operation illustrated in FIG. 3 can be realized by execution of arithmetic processing by the control device (control unit) 62, based on detection results of the respective units. Note that the control device 62 repeatedly executes the processing illustrated in FIG. 3.

First, the control device 62 detects the ease of flow of the compressed air in the SOFC 13 (step S12). To be specific, the control device 62 detects a pressure loss in the SOFC 13, at least based on detection results of the pressure detection unit 82 and the pressure detection unit 84, and detects the ease of flow of the compressed air in the SOFC 13, based on a result thereof. To be more specific, the control device 62 takes the results of the pressure detection unit 80 and the pressure detection unit 84 into account, and performs calculation using balance of the pressure in a path at an air side of the power generation system 10, passage resistances of the respective units, and so on, thereby to detect the ease of flow of the compressed air in the SOFC 13.

When having detected the ease of flow of the compressed air in the SOFC 13, the control device 62 determines whether there is variation in the ease of flow (step S14). For example, when a difference between the ease of flow and the ease of flow of previous adjustment exceeds a set threshold, the control device 62 determines that there is the variation. When having determined that there is no variation (No at step S14), the control device 62 terminates the present processing.

When having determined that there is the variation (Yes at step S14), the control device 62 performs control to change the degree of opening of the bypass control valve 70 (step S16), and terminates the present processing. Here, when having determined that the compressed air becomes easier to flow in the SOFC 13, the control device 62 performs control to decrease the degree of opening of the bypass control valve 70, and when having determined that the compressed air becomes less easy to flow in the SOFC 13, the control device 62 performs control to increase the degree of opening of the bypass control valve 70. As described above, the power generation system 10 can suppress the pressure variation of the compressed air A2 to be supplied to the SOFC 13 and can suppress pressure variation at the cathode side of the SOFC 13 by adjusting the degree of opening of the bypass control valve 70, based on the ease of flow of the compressed air in the SOFC 13. Therefore, the power generation system 10 can maintain the pressure balance between the cathode and the anode of the SOFC 13 constant.

Further, if the balance of the pressure varies in the power generation system 10, the amount or the pressure of the compressed air to be supplied to the combustor 22 may vary. If the compressed air to be supplied to the combustor 22 varies, burning of the fuel gas in the combustor 22 becomes unstable. The power generation system 10 can suppress variation of the balance between the compressed air A2 to be supplied to the SOFC 13 and the compressed air A1 to be supplied to the fuel container 22 by adjusting the degree of opening of the bypass control valve 70 in accordance with the variation of the ease of flow of the compressed air in the SOFC 13. Accordingly, the power generation system 10 also can suppress variation of the amount and the pressure of the compressed air A1 to be supplied to the combustor 22.

Next, another example of the method of driving the power generation system 10 will be described with reference to FIG. 4. FIG. 4 is a flowchart illustrating another example of the drive operation of the power generation system of the present embodiment. The drive operation illustrated in FIG. 4 can be realized by execution of arithmetic processing by the control device (control unit) 62, based on the detection results of respective units. The control device (control unit) 62 executes the processing illustrated in FIG. 4 when detecting abnormality in the SOFC 13 or the gas turbine 11, and stopping the circulation of the exhausted fuel gas and the compressed air between the SOFC 13 and the gas turbine 11.

First, when having detected abnormality in the SOFC 13 or the gas turbine 11 (step S20), the control device 62 performs control to decrease the degrees of opening of the control valve 32 of the second compressed air supply line 31 and the control valve 38 of the compressed air circulating line 36 (step S22), and performs control to increase the degree of opening of the bypass control valve 70 (step S24). Next, the control device 62 determines whether closing of the control valve 32 of the second compressed air supply line 31 and the control valve 38 of the compressed air circulating line 36 has been completed (step S26). When having determined that the closing has not been completed (No at step S26), the control device 62 returns to step S22, and when having determined that the closing has been completed (Yes at step S26), the control device 62 terminates the present processing.

As described above, when abnormality occurs in the SOFC 13 or the gas turbine 11, the power generation system 10 closes the control valve 32 of the second compressed air supply line 31 and the control valve 38 of the compressed air circulating line 36, and stops supply of the compressed air A2 to the SOFC 13 and discharge of the compressed air (exhausted air) A3 from the SOFC 13. Therefore, the power generation system 10 can isolate the SOFC 13 from the gas turbine 11, and can suppress the pressure variation at the cathode side of the SOFC 13. Therefore, the power generation system 10 can maintain the pressure balance between the cathode and the anode of the SOFC 13 constant.

Here, the power generation system 10 detects the pressures of the lines with the pressure detection units, and detects the ease of flow of the compressed air, based on the detected pressures (pressure difference). However, the embodiment is not limited thereto.

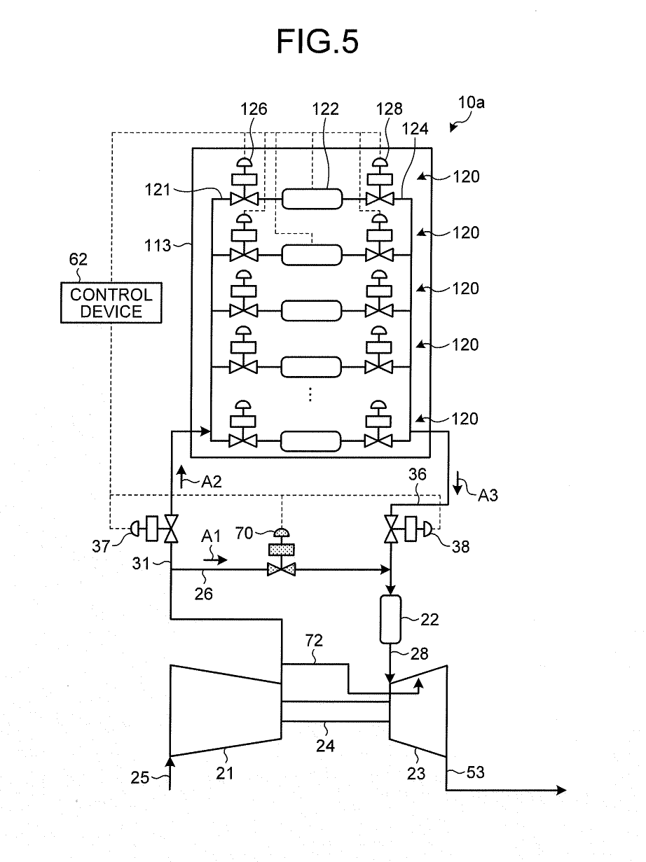

FIG. 5 is a schematic diagram illustrating another example of a gas turbine, an SOFC, and a piping system. In a power generation system 10a illustrated in FIG. 5, an SOFC 113 includes a plurality of unit SOFC units 120. The plurality of unit SOFC units 120 is arranged in parallel. Compressed air A2 is supplied through a second compressed air supply line 31 to each of the plurality of unit SOFC units 120, and compressed air A3 is discharged to a compressed air circulating line 36.

The unit SOFC unit 120 includes an upper stream diverging pipe 121, a unit SOFC 122, a downstream diverging pipe 124, and control valves 126 and 128. One end portion of the upper stream diverging pipe 121 is connected to the second compressed air supply line 31, and the other end portion is connected to the unit SOFC 122. The unit SOFC 122 has a similar configuration to the above-described SOFC 13. The unit SOFC 122 reacts at a predetermined operation temperature and generates power by a high-temperature fuel gas as a reductant and high-temperature air (oxidized gas) as an oxidant being supplied. The unit SOFC 122 is configured such that a cathode, a solid electrolyte, and a anode are housed in a pressure container. The compressed air A2 is supplied through the upper stream diverging pipe 121 to the unit SOFC 122. One end portion of the downstream diverging pipe 124 is connected to the unit SOFC 122, and the other end portion is connected to the compressed air circulating line 36. In the unit SOFC unit 120, the compressed air A2 passes the upper stream diverging pipe 121 through the second compressed air supply line 31 and is supplied to the unit SOFC 122. Further, in the unit SOFC unit 120, the compressed air A3 passes the downstream diverging pipe 124 from the unit SOFC 122, and is discharged to the compressed air circulating line 36.

The control valve 126 is arranged at the upper stream diverging pipe 121. Similarly to the above-described control valves, the control valve 126 adjusts the compressed air A2 flowing in the upper stream diverging pipe 121 by adjusting open/close and the degree of opening. The control valve 128 is arranged at the downstream diverging pipe 124. Similarly to the above-described control valves, the control valve 128 adjusts the compressed air A3 flowing in the downstream diverging pipe 124 by adjusting open/close and the degree of opening.

The unit SOFC unit 120 has the above configuration, and the power generation system 10a can isolate one unit SOFC unit 120 from the path in which the compressed air flows by closing the control valves 126 and 128. Accordingly, in the SOFC 113, drive and stop can be switched for each unit SOFC unit 120, and maintenance and replacement of only one unit SOFC unit 120 can be performed while power generation is performed in other unit SOFC units 120.

A control device 62 may acquire information about the number of the driven or stopped unit SOFC units 120 (unit SOFCs 122), and switch of start and stop of the unit SOFC units 120, as information of the ease of flow of the compressed air in the SOFC 113, and control the bypass control valve 70.

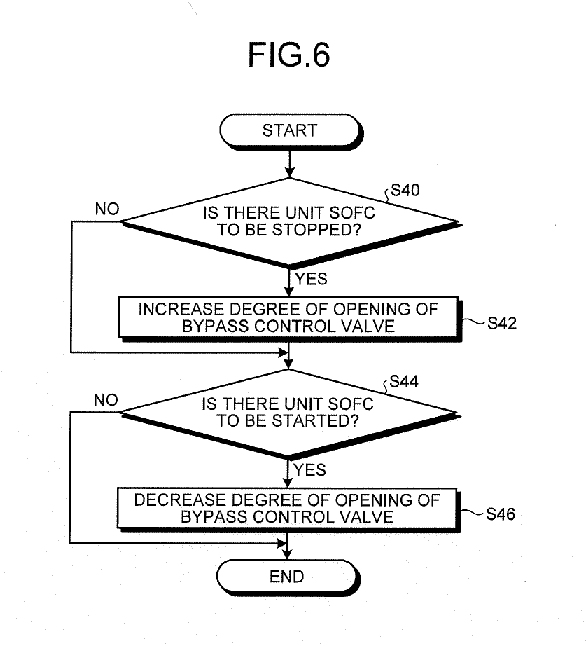

Hereinafter, an example of a drive operation of the power generation system 10a of the above-described present embodiment will be described with reference to FIG. 6. FIG. 6 is a flowchart illustrating an example of a drive operation of the power generation system 10a. The control device 62 determines whether there is a unit SOFC 122 to be stopped (step S40). When having determined that there is a unit SOFC 122 to be stopped (Yes at step S40), the control device 62 performs control to increase the degree of opening of the bypass control valve 70 (step S42). Accordingly, the unit SOFC unit 120 is stopped, so that the compressed air A2 not used in the SOFC 113 can be supplied to the combustor 22 side. Accordingly, even when the unit SOFC 122 is stopped, the power generation system 10a can suppress the pressure variation of the compressed air A2 to be supplied to the unit SOFC 122, and can suppress the pressure variation at the cathode side of the unit SOFC 122.

When having determined that there is no unit SOFC 122 to be stopped (No at step S40), or when having adjusted the degree of opening of the bypass control valve at step S42, the control device 62 determines whether there is a unit SOFC 122 to be started (step S44). When having determined that there is a unit SOFC 122 to be started (Yes at step S44), the control device 62 performs control to decrease the degree of opening of the bypass control valve 70 (step S46). Accordingly, even when the unit SOFC 122 is newly started, the power generation system 10a can suppress the pressure variation of the compressed air A2 to be supplied to other running unit SOFCs 122, and can suppress the pressure variation at the cathode side of the unit SOFCs 122. Therefore, the power generation system 10a can maintain the pressure balance between the cathode and the anode of the unit SOFCs 122 constant.

When having determined that there is no unit SOFC 122 to be started (No at step S44), or when having adjusted the degree of opening of the bypass control valve at step S46, the control device 62 terminates the present processing.

As described above, the power generation system 10a can suppress variation of the pressure of the compressed air A2 to be supplied to the SOFC 113 by adjusting the degree of opening of the bypass control valve 70 according to switch of start and stop of the unit SOFC units 120 (unit SOFCs 122). Further, the power generation system 10a can adjust the bypass control valve 70, based on a control state of the unit SOFC units 120, and thus can perform control easily.

Note that, in the embodiment, the degree of opening of the bypass control valve 70 has been adjusted. However, the present invention is not limited to the embodiment. The power generation system may adjust the balance between the compressed air A2 to be supplied through the second compressed air supply line 31 to the SOFC 113 and the compressed air A1 to be supplied through the first compressed air supply line 26 to the combustor 22 by adjusting the degree of opening of the control valve 37 of the second compressed air supply line 31, based on the ease of flow of the compressed air in the SOFC 113.

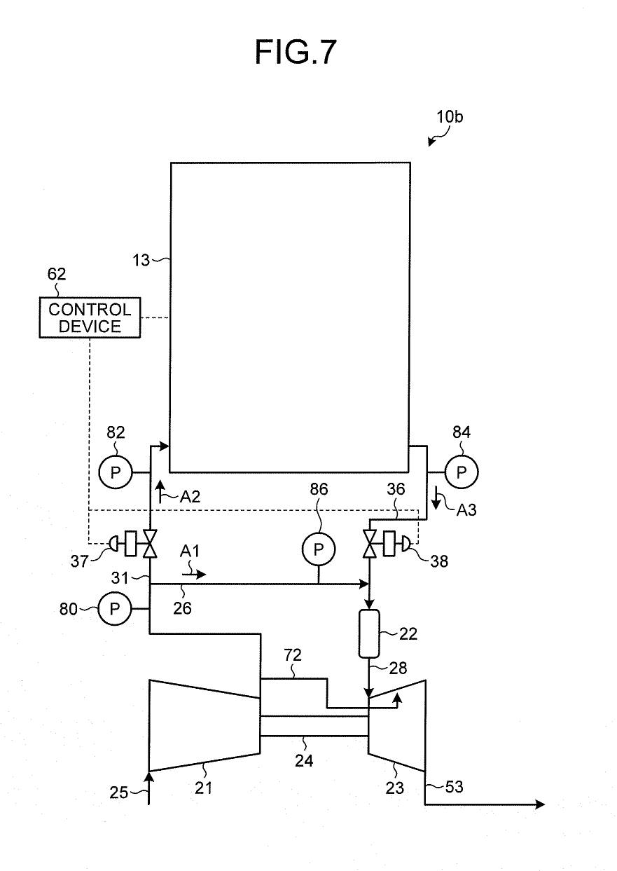

FIG. 7 is a schematic diagram illustrating another example of a gas turbine, an SOFC, and a piping system. A power generation system 10b illustrated in FIG. 7 has a similar configuration to the power generation system 10 illustrated in FIG. 2 except that a bypass control valve 70 is not provided at a first compressed air supply line 26. Note that the power generation system 10b may not include a pressure detection unit 86. The power generation system 10b adjusts balance between compressed air A2 to be supplied through a second compressed air supply line 31 to an SOFC 13 and compressed air A1 to be supplied through a first compressed air supply line 26 to a combustor 22 by adjusting a control valve 37, based on ease of flow of compressed air in the SOFC 13. Accordingly, the power generation system 10b can adjust the balance without including the bypass control valve 70.

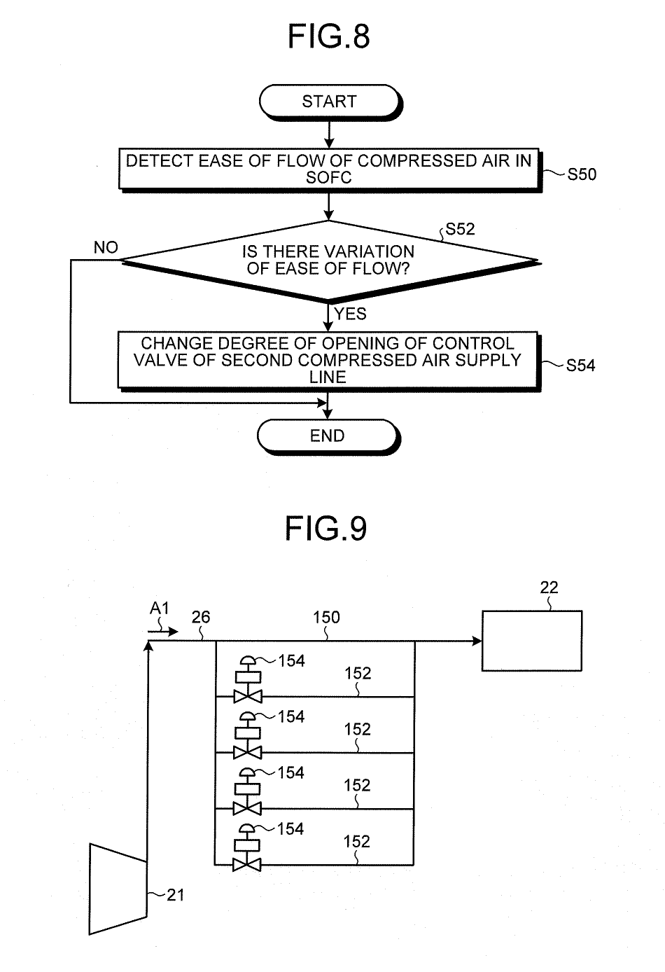

FIG. 8 is a flowchart illustrating an example of a drive operation of the power generation system of the power generation system 10b of the above-described present embodiment. First, a control device 62 detects ease of flow of the compressed air in the SOFC 13 (step S50). When having detected the ease of flow of the compressed air in the SOFC 13, the control device 62 determines whether there is variation in the ease of flow (step S52). When having determined that there is no variation (No at step S52), the control device 62 terminates the present processing.

When having determined that there is variation (Yes at step S52), the control device 62 performs control to change the degree of opening of the control valve 37 of the second compressed air supply line 31 (step S54), and terminates the present processing. Here, when having determined that the compressed air becomes easier to flow in the SOFC 13, the control device 62 performs control to decrease the degree of opening of the control valve 37, and when having determined that the compressed air becomes less easy to flow in the SOFC 13, the control device 62 performs control to increase the degree of opening of the control valve 37.

As described above, the power generation system 10b can suppress the pressure variation of the compressed air A2 to be supplied to the SOFC 13, and can suppress the pressure variation at an cathode side of the SOFC 13 by adjusting the degree of opening of the control valve 37, based on the ease of flow of the compressed air in the SOFC 13. Therefore, the power generation system 10b can maintain the pressure balance between a cathode and a anode of the SOFC 13 constant.

Further, in all of the above-described embodiments, the ease of flow of the air in the respective lines has been adjusted using control valves with an adjustable degree of opening. However, the present invention is not limited to the embodiments. The principle and the configuration of the power generation system are not especially limited as long as the power generation system has a mechanism (adjustment unit) that can adjust the ease of flow of the air.

FIG. 9 is a schematic configuration diagram illustrating another example of a first compressed air supply line. A first compressed air supply line 26 illustrated in FIG. 9 includes, as the mechanism (adjustment unit) that can adjust ease of flow of compressed air, main piping 150, a plurality of diverging pipes 152, and a plurality of open/close valves 154. The main piping 150 is included in a part of the first compressed air supply line 26. The main piping 150 sends compressed air supplied from a compressor 21 to a combustor 22. The diverging pipes 152 are piping in which one end portions of the diverging pipes 152 are connected to the main piping 150, and the other end portions are connected to the main piping 150. That is, the diverging pipes 152 are piping that bypasses the main piping 150. The plurality of diverging pipes 152 is formed in parallel. Compressed air A1 that flows in the first compressed air supply line 26 flows in the main piping 150 and only one of the plurality of diverging pipes 152, at the time of circulation in the range bypassed with the diverging pipes 152. One open/close valve 154 is provided to each of the diverging pipes 152. The open/close valves 154 switch open/close of the installed diverging pipes 152.

The adjustment unit illustrated in FIG. 9 can adjust the ease of flow of the compressed air A1 in the first compressed air supply line 26 by adjusting a ratio of the number of the open/close valves 154 in an open state and the number of the open/close valves 154 in a close state. To be specific, the compressed air A1 becomes easier to flow by an increase in the number of the open/close valves 154 in an open state, and the compressed air A1 becomes less easy to flow by a decrease in the number of open/close valves 154 in an open state.

### REFERENCE SIGNS LIST

10, 10a, and 10b POWER GENERATION SYSTEM
11 GAS TURBINE
12 GENERATOR
13 and 113 SOLID OXIDE FUEL CELL (SOFC)
14 STEAM TURBINE
15 GENERATOR
21 COMPRESSOR
22 COMBUSTOR
23 TURBINE
25 AIR TAKING-IN LINE
26 FIRST COMPRESSED AIR SUPPLY LINE
27 FIRST FUEL GAS SUPPLY LINE
31 SECOND COMPRESSED AIR SUPPLY LINE
32 CONTROL VALVE
33, 48 BLOWER
34 EXHAUSTED AIR LINE
36 COMPRESSED AIR CIRCULATING LINE
38 CONTROL VALVE
41 SECOND FUEL GAS SUPPLY LINE
42 CONTROL VALVE
43 EXHAUSTED FUEL LINE
44 DISCHARGE LINE
45 EXHAUSTED FUEL GAS SUPPLY LINE
47 CONTROL VALVE
49 FUEL GAS RECIRCULATING LINE
50 RECIRCULATING BLOWER
51 EXHAUSTED HEAT RECOVERY BOILER
52 TURBINE
53 FLUE GAS LINE
54 STEAM SUPPLY LINE
55 FEED WATER LINE
56 CONDENSER
57 FEED WATER PUMP
62 CONTROL DEVICE (CONTROL UNIT)
70 BYPASS CONTROL VALVE
72 COOLING AIR SUPPLY LINE
80, 82, 84, and 86 PRESSURE DETECTION UNIT
520 UNIT SOFC UNIT
521 UPPER STREAM DIVERGING PIPE
522 UNIT SOFC
524 DOWNSTREAM DIVERGING PIPE
526 and 128 CONTROL VALVE
550 MAIN PIPING
552 DIVERGING PIPE
554 OPEN/CLOSE VALVE

1. A power generation system comprising:
a fuel cell;
a gas turbine including a compressor and a combustor;
a first compressed air supply line configured to supply compressed air from the compressor to the combustor;
a second compressed air supply line configured to supply the compressed air from the compressor to the fuel cell;
a compressed air circulating line configured to supply exhausted air from the fuel cell to the combustor;
a detection unit configured to detect ease of flow of compressed air in the fuel cell;
an adjustment unit configured to adjust balance between ease of flow of the compressed air in the first compressed air supply line and ease of flow of the compressed air in the second compressed air supply line; and
a control device configured to adjust the balance between ease of flow of the compressed air in the first compressed air supply line and ease of flow of the compressed air in the second compressed air supply line by the adjustment unit, based on variation of the ease of flow of the compressed air in the fuel cell detected in the detection unit.

2. The power generation system according to claim 1, wherein the adjustment unit includes a mechanism arranged at the first compressed air supply line, and which adjusts the ease of flow of the compressed air in the first compressed air supply line.

3. The power generation system according to claim 2, wherein the adjustment unit includes a control valve with an adjustable degree of opening, arranged at the first compressed air supply line.

4. The power generation system according to claim 2, wherein the adjustment unit includes main piping arranged at the first compressed air supply line, at least one diverging pipe that bypasses the main piping, and an open/close valve arranged at the diverging pipe.

5. The power generation system according to claim 1, wherein, when the compressed air becomes less easy to flow to the fuel cell, the control device causes the compressed air to become easy to flow in the first compressed air supply line.

6. The power generation system according to claim 1, wherein the adjustment unit includes a mechanism arranged at the second compressed air supply line, and which adjusts the ease of flow of the compressed air in the second compressed air supply line.

7. The power generation system according to claim 6, wherein the adjustment unit includes a control valve with an adjustable degree of opening arranged at the second compressed air supply line.

8. The power generation system according to claim 1, wherein, when the compressed air becomes less easy to flow to the fuel cell, the control device causes the compressed air to become less easy to flow in the second compressed air supply line.

9. The power generation system according to claim 1, wherein, when the control device determines to block a circulating path of the compressed air of the fuel cell and the gas turbine, the control device repeats control to cause the compressed air to become less easy to flow in the second compressed air supply line and to cause the compressed air to become easier to flow in the first compressed air supply line by the adjustment unit, to close the second compressed air supply line.

10. The power generation system according to claim 1, wherein the detection unit includes a first pressure detection unit that detects a pressure of the compressed air flowing in the first compressed air supply line, and a second pressure detection unit that detects a pressure of the compressed air flowing in the compressed air circulating line, and detects the ease of flow of the compressed air in the fuel cell, based on a result detected in the first pressure detection unit and a result detected in the second pressure detection unit.

11. A method of operating a power generation system including a fuel cell, a gas turbine including a compressor and a combustor, a first compressed air supply line that supplies compressed air from the compressor to the combustor, a second compressed air supply line that supplies the compressed air from the compressor to the fuel cell, and a compressed air circulating line that supplies exhausted air from the fuel cell to the combustor, the method comprising:
detecting ease of flow of compressed air in the fuel cell; and
adjusting balance between ease of flow of the compressed air in the first compressed air supply line and ease of flow of the compressed air in the second compressed air supply line by the adjustment unit, based on variation of the ease of flow of the compressed air in the fuel cell detected in the detection unit.
